(19) United States
(12) Patent Application Publication
(10) Pub. No.: US 2025/0274653 A1
(43) Pub. Date: Aug. 28, 2025

(54) ELECTRONIC DEVICE AND SHOOTING MANAGEMENT METHOD

(71) Applicant: Panasonic Intellectual Property Management Co., Ltd., Osaka (JP)

(72) Inventors: Takuya IGUCHI, Osaka (JP); Toshinari SUO, Osaka (JP); Shinichi YAMAMOTO, Osaka (JP); Hiroki KASUGAI, Osaka (JP)

(73) Assignee: Panasonic Intellectual Property Management Co., Ltd., Osaka (JP)

(21) Appl. No.: 19/062,107

(22) Filed: Feb. 25, 2025

(30) Foreign Application Priority Data
Feb. 26, 2024 (JP) 2024-026772

(51) Int. Cl. H04N 23/60; G10L 21/028; G10L 25/57; H04N 23/63

(52) U.S. Cl. CPC H04N 23/64; G10L 25/57; H04N 23/634; G10L 21/028

(57) ABSTRACT

An electronic device manages video shooting. The electronic device includes: a display that displays information; an input interface that inputs a user operation; and a controller that controls the display according to the user operation input in the input interface. The controller receives an instruction to shoot a video in the input interface, and acquires a result of determination processing to determine whether or not the video is a mistake shot, based on audio data in the shot video. When the acquired result of the determination processing is the mistake shot, the controller displays alert information indicating the mistake shot of the video on the display.

### TECHNICAL FIELD

The present disclosure relates to an electronic device and a shooting management method for managing video shooting including sound collection.

### BACKGROUND ART

JP 2013-117659 A discloses a voice processing device for an input signal of voice recognition of a speaker. The voice processing device determines the noise and the voice of the speaker, and adjusts the gain of a sound input interface on the basis of the determination result so that the noise level is equal to or lower than a first level. When the level of the voice becomes equal to or lower than a second level as a result, the voice processing device issues a warning to the speaker. As a result, when the voice of the speaker is input, the voice of the speaker can be set to the second level or higher, and when noise is input, the voice can be set to the first level or lower. As a result, the SN ratio is improved.

JP 2022-141581 A discloses a sound source separation device that separates a target signal and a non-target signal other than the target signal from an acoustic signal. A sound source separation device separates the acoustic signal into the target signal and the non-target signal by using various neural networks for the purpose of reducing an operation amount of a neural network model for obtaining the target signal from the acoustic signal.

### SUMMARY

The present disclosure provides an electronic device and a shooting management method that can facilitate management of mistake shot for sound collection in video shooting.

In the present disclosure, an electronic device manages video shooting. The electronic device includes: a display that displays information; an input interface that inputs a user operation; and a controller that controls the display according to the user operation input in the input interface. The controller receives an instruction to shoot a video in the input interface, and acquires a result of determination processing to determine whether or not the video is a mistake shot, based on audio data in the shot video. When the acquired result of the determination processing is the mistake shot, the controller displays alert information indicating the mistake shot of the video on the display.

In the present disclosure, a shooting management method is a method for managing video shooting. The method includes: receiving, by a controller of an electronic device, an instruction to shoot a video in an input interface, acquiring, by the controller, a result of determination processing to determine whether or not the video is mistake shot, based on audio data in the shot video, and displaying, by the controller, alert information on a display, the alert information indicating the mistake shot of the video when the acquired result of the determination processing is the mistake shot.

According to the electronic device and the shooting management method of the present disclosure, it is possible to facilitate to manage mistake shot for sound collection in video shooting.

### BRIEF DESCRIPTION OF DRAWINGS

FIG. 1 is a diagram illustrating a configuration of an imaging system according to a first embodiment of the present disclosure;

FIG. 2 is a diagram illustrating a configuration of a digital camera in the imaging system;

FIG. 3 is a diagram illustrating a configuration of an information support terminal in the imaging system;

FIG. 4 is a diagram illustrating a display example of a function selection screen in the information support terminal;

FIG. 5 is a diagram illustrating a display example of a scenario input screen in the information support terminal;

FIG. 6 is a diagram illustrating a data structure of cut allocation data in the information support terminal;

FIG. 7 is a diagram illustrating a display example of a cut selection screen in the information support terminal;

FIG. 8 is a flowchart illustrating an operation of a cut shooting function in the imaging system;

FIG. 9 is a diagram illustrating a display example of a rating screen in the information support terminal;

FIG. 10 is a diagram illustrating a cut list in a case with a sound NG cut;

FIG. 11 is a flowchart illustrating recording mode processing in the imaging system;

FIGS. 12A and 12B are diagrams illustrating a display example in the recording mode of the information support terminal;

FIG. 13 is a diagram illustrating a data structure of video metadata in the information support terminal;

FIG. 14 is a flowchart illustrating sound determination processing in the imaging system according to the first embodiment;

FIGS. 15 is a diagram illustrating a display example of an alert message in the information support terminal;

FIG. 16 is a flowchart illustrating video playback processing for sound NG in the imaging system;

FIG. 17 is a diagram illustrating a display example of a video playback screen for sound NG in the information support terminal;

FIGS. 18 is a diagram illustrating a display example of noise decomposition in the information support terminal;

FIG. 19 is a diagram for explaining an NG criterion setting operation in the information support terminal;

FIG. 20 is a flowchart illustrating sound determination processing in the imaging system according to a second embodiment; and

FIG. 21 is a diagram for explaining a modification of the digital camera.

### DETAILED DESCRIPTION

Embodiments will be described in detail below with reference to the drawings as appropriate. However, detailed description of already well-known matters and redundant description of substantially the same configuration may be omitted. Note that the accompanying drawings and the following description are provided for those skilled in the art to fully understand the present disclosure, and are not intended to limit the subject matter described in the claims.

### FIRST EMBODIMENT

In a first embodiment of the present disclosure, a system using an electronic device separate from an imaging apparatus that executes video shooting will be described.

### 1. Configuration

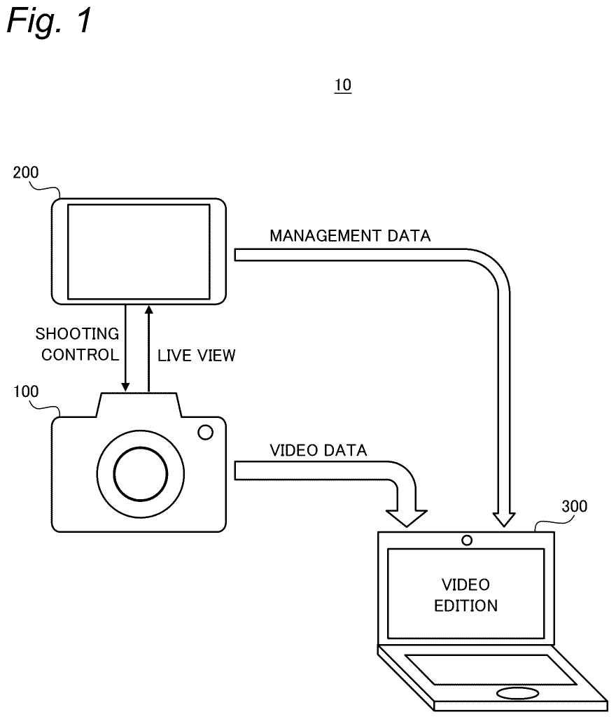

An imaging system according to the first embodiment of the present disclosure will be described with reference to FIG. 1.

For example, as illustrated in FIG. 1, a system 10 includes a digital camera 100, an information support terminal 200, and a video editing personal computer (PC) 300. In the present system 10, the digital camera 100 and the information support terminal 200 are data-communicably connected by wired communication or wireless communication, for example.

The present system 10 is applicable to a user creating a desired video work by shooting and editing a plurality of videos with the digital camera 100, for example. For example, the present system 10 provides information support useful for a series of workflows in which a user plans a scenario indicating a concept of a video work, repeatedly shoot a video according to a plurality of cuts that are divided from the scenario, and edits a plurality of shot videos.

In the present system 10, the information support terminal 200 can manage a scenario of a video work, and control the digital camera 100 so as to manage video shooting for each cut, for example. For example, a live view image in the digital camera 100 can be viewed on the information support terminal 200. The video data of the shooting result of the digital camera 100 is edited in the video editing PC 300. The present system 10 uses data managed by the information support terminal 200 from the viewpoint of facilitating video editing in the video editing PC 300 and the like.

In the present system 10, the video editing PC 300 may or may not be communicably connected to one or both of the digital camera 100 and the information support terminal 200. For example, data from the digital camera 100 and/or the information support terminal 200 may be input to the video editing PC 300 via a portable recording medium such as a memory card. The present system 10 may not include the video editing PC 300.

### 1.1. Configuration of Digital Camera

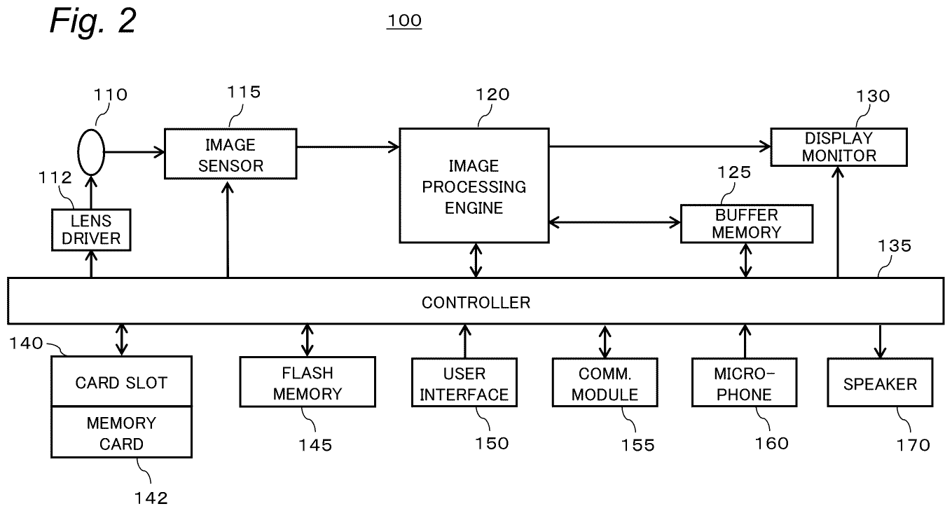

A configuration of the digital camera 100 in the present embodiment will be described with reference to FIG. 2.

FIG. 2 is a diagram illustrating the configuration of the digital camera 100 in the present system 10. The digital camera 100 is an example of an imaging apparatus in the present embodiment. The digital camera 100 according to the present embodiment includes an image sensor 115, an image processing engine 120, a display monitor 130, and a controller 135. Further, the digital camera 100 includes a buffer memory 125, a card slot 140, a flash memory 145, a user interface 150, a communication module 155, a microphone 160, and a speaker 170. Furthermore, the digital camera 100 includes an optical system 110 and a lens driver 112, for example.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like includes one lens or more lenses.

The lens driver 112 drives the focus lens and the like in the optical system 110. The lens driver 112 includes a motor, to move the focus lens along the optical axis of the optical system 110 under the control of the controller 135. The configuration for driving the focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 performs an operation of capturing a still image, an operation of capturing a through image, and the like. The through image is mainly a video, and is displayed on the display monitor 130 in order for the user to determine a composition for capturing a still image. Each of the through image and the still image is an example of a captured image in the present embodiment. The image sensor 115 is an example of an imager in the present embodiment.

The image processing engine 120 performs various processing on the imaging data output from the image sensor 115 to generate image data, and performs various processing on the image data to generate an image to be displayed on the display monitor 130. Examples of various processing include white balance correction, gamma correction, YC conversion processing, electronic zoom processing, compression processing, expansion processing, and the like, but the various processing are not limited thereto. The image processing engine 120 may be configured by a hard-wired electronic circuit, or may be configured by a microcomputer using a program, a processor, or the like.

The display monitor 130 is an example of a display that displays various information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be configured by a liquid crystal display device or an organic EL device, for example.

The user interface 150 is a general term for hard keys such as operation buttons and operation levers provided on the exterior of the digital camera 100, operable to receive an operation by the user. For example, the user interface 150 includes a release button, a mode dial, and a touch panel. When the user interface 150 receives an operation by the user, the user interface 150 transmits an operation signal corresponding to the user operation to the controller 135.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Although not illustrated, the controller 135 may include various internal memories, and may incorporate a ROM, for example. The ROM stores various programs to be executed by the controller 135. The controller 135 may incorporate a RAM that functions as a work area of the CPU.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155.

The microphone 160 includes one or more microphone elements incorporated in the digital camera 100, for example. The microphone 160 outputs a sound signal indicating the collected sound to the controller 135. An external microphone may be used in the digital camera 100. The digital camera 100 may include a connector such as a terminal connected to an external microphone instead of or in addition to the built-in microphone 160.

The speaker 170 includes one or more speaker elements built in the digital camera 100 and outputs sound to the outside of the digital camera 100 under the control of the controller 135, for example. In the digital camera 100, an external speaker, an earphone, or the like may be used. The digital camera 100 may include a connector connected to an external speaker or the like instead of or in addition to the built-in speaker 170.

### 1.2. Configuration of Information Support Terminal

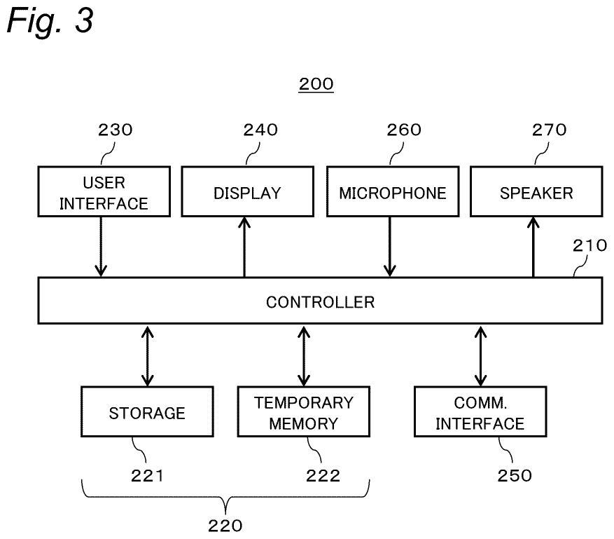

A configuration of the information support terminal 200 in the present embodiment will be described with reference to FIG. 3.

FIG. 3 is a diagram illustrating the configuration of the information support terminal 200. The information support terminal 200 is an example of an electronic device including a smartphone, a tablet terminal, a PC, or the like, for example. The information support terminal 200 illustrated in FIG. 3 includes a controller 210, a memory 220, a user interface 230, a display 240, a communication interface 250, a microphone 260, and a speaker 270.

The controller 210 includes a CPU or an MPU that realizes a predetermined function in cooperation with software, for example. The controller 210 controls the overall operation of the information support terminal 200, for example. The controller 210 reads data and programs stored in the memory 220 and performs various calculation processing to realize various functions.

For example, the controller 210 executes a program including a command group for realizing each of the above-described functions. The above program may be provided from a communication network such as the Internet, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a memory medium that stores programs and data necessary for implementing the functions of the information support terminal 200. As illustrated in FIG. 3, the memory 220 includes a storage 221 and a temporary memory 222.

The storage 221 stores parameters, data, control programs, and the like for realizing a predetermined function. The storage 221 includes an HDD or an SSD, for example. For example, the storage 221 stores the above-described programs, various image data, and the like.

The temporary memory 222 includes a RAM such as a DRAM or an SRAM, to temporarily store (i.e., hold) data, for example. For example, the temporary memory 222 holds image data in the middle of being edited. In addition, the temporary memory 222 may function as a work area of the controller 210, and may be configured by a storage area in an internal memory of the controller 210.

The user interface 230 is a general term for operation members operated by a user. For example, the user interface 230 is a touch panel superimposed on the display 240 to input various touch operations, and is an example of an input interface of the information support terminal 200. The input interface may be a connection software unit that is communicably connected to various external input devices and receives an operation signal. The user interface 230 may be a physical button, a switch, or the like provided in the information support terminal 200, or a keyboard, a mouse, a touch pad, or the like may be used. The user interface 230 may be various GUIs such as virtual buttons and icons, cursors, software keyboards, and objects displayed on the display 240.

The display 240 includes a liquid crystal display or an organic EL display, for example. The display 240 may display various information such as various GUIs for operating the user interface 230 and information input from the user interface 230.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the information support terminal 200 to a communication network such as the Internet. The communication interface 250 is an example of an input interface that receives various information from an external device or a communication network.

The microphone 260 includes one or more microphone elements incorporated in the information support terminal 200, for example. The microphone 260 outputs a sound signal indicating the collected sound to the controller 210. The information support terminal 200 may include a connector such as a terminal connected to an external microphone instead of or in addition to the built-in microphone 260.

The speaker 270 includes one or more speaker elements built in the digital camera 100, and outputs a sound to the outside of the information support terminal 200 under the control of the controller 210, for example. The information support terminal 200 may include a connector connected to an external speaker, an earphone, or the like instead of or in addition to the built-in speaker 270.

The configuration of the information support terminal 200 as described above is an example, and the configuration of the information support terminal 200 is not limited thereto. For example, various display devices such as a projector and a head mounted display may be used as the display 240 of the information support terminal 200. For example, when an external display device is used, the display 240 of the information support terminal 200 may be an output interface circuit such as a video signal conforming to the HDMI standard or the like.

### 2. Operation

The operation of the present system 10 configured as described above will be described below.

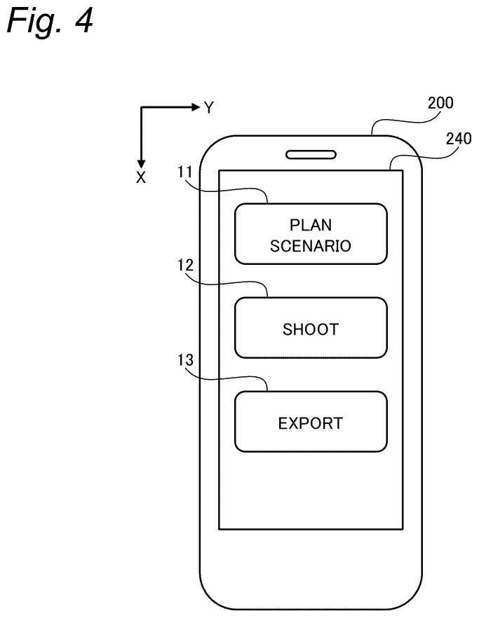

In the present system 10, the information support terminal 200 has various functions for sequentially providing information support to the user in the workflow of video production. A display example of a screen for selecting various functions of the information support terminal 200 is illustrated in FIG. 4.

The display 240 of the information support terminal 200 displays a scenario planning button 11, a shooting button 12, and an export button 13 on the function selection screen illustrated in FIG. 4. Hereinafter, the longitudinal direction on the screen of the display 240 is defined as an X direction, and the width direction is defined as a Y direction.

The scenario planning button 11 is a virtual button that responds a user operation to execute a function (i.e., a scenario planning function) of performing information support for a process of planning a scenario by the user before shooting a video in the present system 10. The information support terminal 200 of the present system 10 manages various information for each cut such as a shooting section that divides the scenario planned in this way. The cut constitutes a section in a plurality of times of video shooting for a scenario, for example.

For example, the shooting button 12 is a virtual button for executing a function (i.e., a cut shooting function) of supporting video shooting of each cut in a scenario planned by the scenario planning function. The number of times of shooting a video for one cut is not particularly limited to one take, and may be a plurality of takes. In the present embodiment, the information support terminal 200 controls video shooting by the digital camera 100 in the cut shooting function, and manages an shooting result for each cut.

The export button 13 is a virtual button for executing a function (i.e., an export function) of performing pre-processing for external output on a management result of video shooting by the cut shooting function and outputting the result. The pre-processing by the export function provides information support for facilitating a process of editing a video of a plurality of shooting results according to a scenario in the video editing PC 300, for example.

The information support terminal 200 of the present system 10 can provide comprehensive information support from planning of a scenario to pre-processing of video editing when the user sequentially uses the functions of the scenario planning button 11, the shooting button 12, and the export button 13, for example.

In the present system 10, the function selection screen of the information support terminal 200 may further include a delete button for deleting various data in the information support as described above. For example, the information support terminal 200 may collectively delete the video files of the same scenario in response to the user operation of the delete button.

### 2.1. Scenario Planning Function

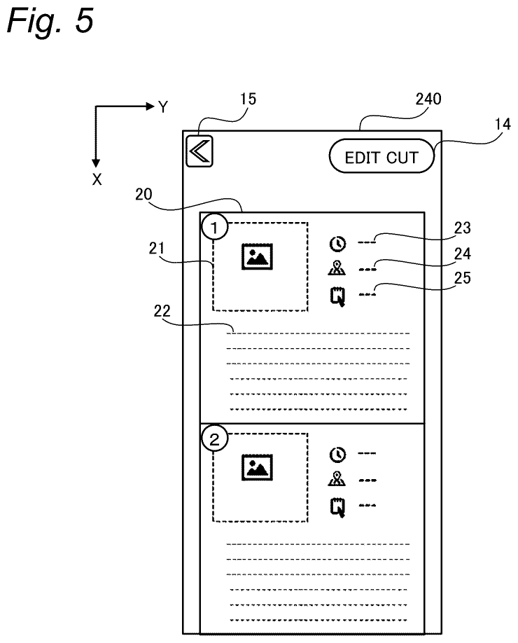

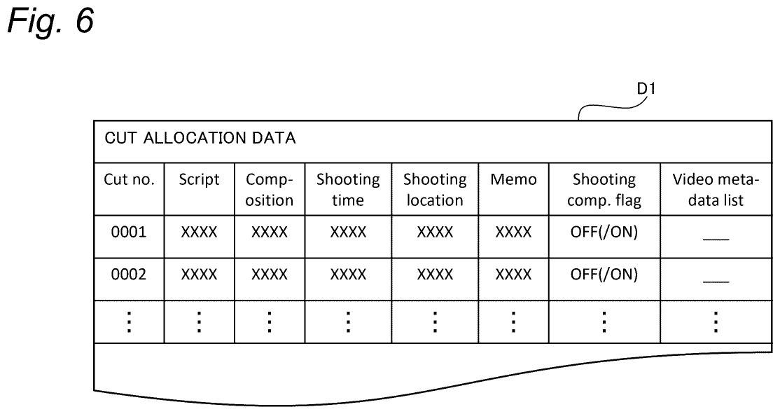

The scenario planning function in the information support terminal 200 of the present system 10 will be described with reference to FIGS. 5 to 6.

FIG. 5 illustrates a display example of a scenario input screen in the information support terminal 200. When a user operation such as tapping the scenario planning button 11 on the function selection screen of FIG. 4 is input from the user interface 230, the controller 210 of the information support terminal 200 displays a scenario input screen on the display 240 as illustrated in FIG. 5.

The scenario input screen is a screen for the user to input a scenario to the information support terminal 200 in the scenario planning function of the present system 10. As illustrated in FIG. 5 the scenario input screen includes a storyboard input field 20 for each cut, a cut edit button 14, and a return button 15, for example. The controller 210 of the information support terminal 200 causes the user interface 230 to receive various user operations related to the scenario input screen displayed on the display 240.

In the information support terminal 200, the storyboard input field 20 receives a user input of information indicating a storyboard such as an outline of a scenario concept for each cut constituting a scenario. As illustrated in FIG. 5 the storyboard input field 20 for each cut includes a composition field 21, a script field 22, an shooting time field 23, an shooting location field 24, and a memo field 25, for example.

The composition field 21 receives an input of image information indicating a composition or the like in the video shooting of the cut. The input of the image information may be drawing by user operation or designation of image data. The script field 22 receives a text input such as a script divided for the cut in the scenario.

The shooting time field 23 receives a numerical value input indicating a rough time length for shooting the video of the cut. The shooting location field 24 receives an input of information indicating a location where the video of the cut is shot. The input of the shooting location may be text input, or data search or the like may be appropriately used. The memo field 25 receives an input of various information desired by the user, such as shooting equipment, with respect to the video shooting of the cut by text input, for example.

In the example of FIG. 5, the display 240 displays a storyboard input field 20 for two cuts. The controller 210 acquires the storyboard information for each cut according to the user input to the various fields 21 to 25 in the storyboard input field 20 for each cut in the scenario. On the scenario input screen of the information support terminal 200, the storyboard input field 20 of the cut displayed on the display 240 can be changed according to a swipe operation for scrolling in the X direction in which the storyboard input field 20 for each cut is arranged, for example.

The cut edit button 14 switches on/off of a state in which various user operations such as addition, deletion, and order change of cuts included in the scenario can be input. For example, by a touch operation in the on state of the cut edit button 14, the user can arrange the storyboard input fields 20 for a desired number of cuts in order in time series in the scenario.

The return button 15 responds a user operation to return the screen transition in the information support terminal 200 by one screen. For example, the controller 210 causes the display 240 to transition to the function selection screen (FIG. 4) in response to the user operation of the return button 15 on the scenario input screen (FIG. 5). As an output of such a scenario planning function, the controller 210 according to the present embodiment generates cut allocation data including storyboard information of each cut and stores the cut allocation data in the memory 220. The cut allocation data at the end of such a scenario planning function is illustrated in FIG. 6.

For example, as illustrated in FIG. 6, cut allocation data D1 manages “script”, “composition”, “shooting time”, “shooting location”, “shooting completion flag”, and “video metadata list” in association with each other for each “cut number”. The cut allocation data D1 is an example of management information in the present embodiment.

For example, the controller 210 of the information support terminal 200 assigns cut numbers indicating cut identification information in the cut allocation data D1 in ascending order in the storyboard input field 20 for each cut arranged on the scenario input screen. When the cut order is changed, the controller 210 re-assigns the cut numbers according to the changed order. For each cut, the controller 210 records each piece of information input to the script field 22, the composition field 21, the shooting time field 23, the shooting location field 24, and the memo field 25 of the storyboard input field 20 in “script”, “composition”, “shooting time”, “shooting location”, and “memo” of the cut allocation data D1, respectively.

In the cut allocation data D1, the “shooting completion flag” manages whether the cut is in a state of imaging completion or in a state of imaging incompletion by ON/OFF. At the end of the scenario planning function, the shooting completion flag is set to OFF for all cuts as an initial setting.

The “video metadata list” is a list for storing metadata of a video shot in association with the cut. At the end of the scenario planning function, the video metadata list is set to an empty value as an initial setting.

As described above, according to the scenario planning function in the information support terminal 200 of the present system 10, by generating the cut allocation data D1 from the user input on the scenario input screen, the information support of the process of planning the scenario of the video work desired by the user for each cut can be performed.

The scenario planning function of the information support terminal 200 is not particularly limited to the above. For example, the information support terminal 200 may receive a user instruction for outputting data of the storyboard information of the scenario input on the scenario input screen using a data format (e.g., PDF format) that can be shared by another device, and perform the data output.

### 2.2. Cut Shooting Function

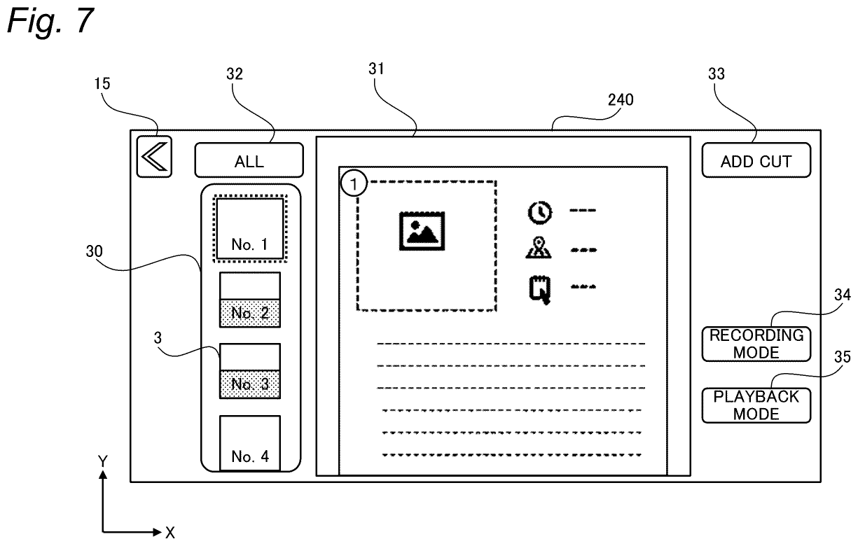

An outline of an operation of the cut shooting function in the information support terminal 200 of the present system 10 will be described with reference to FIG. 7.

FIG. 7 illustrates a display example of a cut selection screen on the information support terminal 200. The cut selection screen is a screen for selecting a cut desired by the user from cuts provided in the scenario planning function in the cut shooting function of the present system 10, for example. The cut selection screen is an example of a selection screen in the information support terminal 200 according to the present embodiment.

As illustrated in FIG. 7, the cut selection screen includes a cut list 30, a storyboard display field 31, a filter button 32, a cut addition button 33, a recording mode button 34, a playback mode button 35, and a return button 15, for example. The cut list 30 is a list listing various cuts as options selectable by the user. The storyboard display field 31 is a display field for displaying storyboard information on the selected cut. Details of the cut selection screen will be described later.

In the cut shooting function of the present system 10, the information support terminal 200 provides information support that facilitates the user to comprehensively carry out video shooting of each cut with checking various cuts, by using the cut selection screen illustrated in FIG. 7, for example. The user may perform video shooting in an order different from the cut order in the scenario, or may perform video shooting of a plurality of takes for video shooting of one cut.

Therefore, the information support terminal 200 of the present system 10 receives the rating by the user of the video for the selected cut at shooting the video of each take, manages whether or not the shooting of the cut is completed, and visualizes the progress status of the video shooting for each cut in the cut list 30 for the user. Hereinafter, details of the operation of the present system 10 will be described.

### 2.2.1. Overall Operation of Cut Shooting Function

The overall operation of the cut shooting function in the present system 10 will be described with reference to FIGS. 7 to 10.

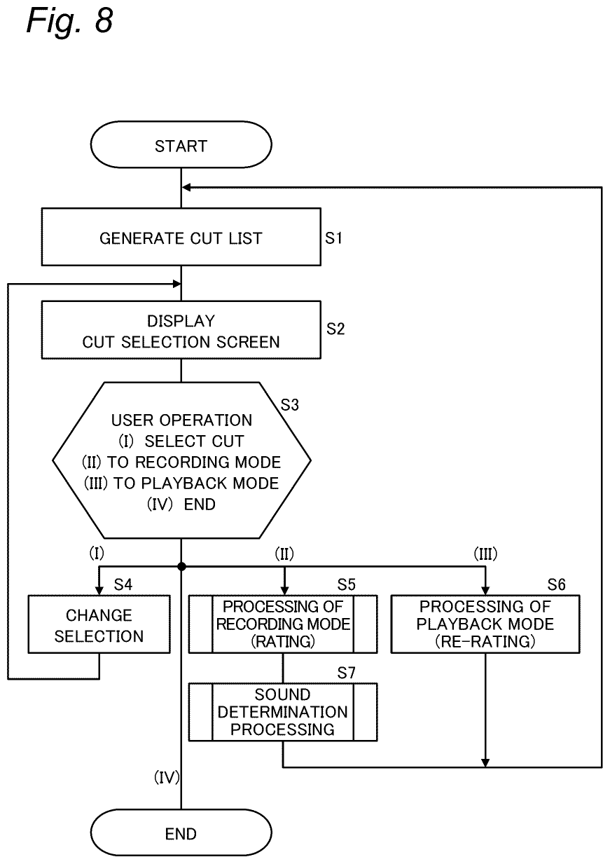

FIG. 8 is a flowchart illustrating an operation of the cut shooting function in the present system 10. Each processing illustrated in the flowchart of FIG. 8 is executed by the controller 210 of the information support terminal 200, for example. For example, the processing of this flow is started when the shooting button 12 on the function selection screen (FIG. 4) is operated in a state where the cut allocation data DI by the scenario planning function is stored in the memory 220 and the communication connection with the digital camera 100 is established in the communication interface 250.

First, the controller 210 of the information support terminal 200 generates the cut list 30 to be displayed on the cut selection screen (FIG. 7) on the basis of the cut allocation data D1 (S1). For example, the cut list generation processing (S1) is repeatedly executed in the present system 10 in accordance with the progress status of video shooting and various operations of the user during execution of the cut shooting function, and sequentially updates the cut list 30. Details of the processing of step S1 will be described later.

Next, the controller 210 causes the display 240 to display a cut selection screen on the basis of the generated cut list 30 and the cut allocation data D1 as illustrated in FIG. 7, for example (S2).

As illustrated in FIG. 7 the cut list 30 on the cut selection screen includes a plurality of cut icons 3. Each cut icon 3 indicates an individual cut as an option, for example. The selected cut icon 3 is set to the cut number “1” in the initial state, for example.

For example, the controller 210 controls the display 240 to highlight the cut icon 3 indicating the selected cut (S2). For example, the highlighting of the selected cut icon 3 is a larger display size than that of the other cut icons 3, a frame enclosure of a highlight color, and the like. Referring to the cut allocation data D1, the controller 210 causes the storyboard display field 31 to display the storyboard information about the cut indicated by the selected cut icon 3 (S2).

In the example of FIG. 7, the cut of the cut numbers “1” and “4” is in a state where imaging is not completed, and the cut of the cut numbers “2” and “3” is in a state where imaging is completed. In the cut list 30 according to the present embodiment, the cut icon 3 has a display attribute for identifying a state of imaging completion and a state of imaging incomplete. For example, such a display attribute is set so as to highlight the display mode in which the display mode of the shooting completion state is the imaging incomplete state.

The controller 210 receives various user operations with the user interface 230 such as a touch panel while the display 240 displays the cut selection screen as illustrated in FIG. 7, for example (S3). The target user operation in step S3 includes (I) a cut selection operation, (II) a transition operation to the recording mode, (III) a transition operation to the playback mode, and (IV) an end operation.

The cut selection operation ((I) in S3) is a user operation of changing the selected cut, and is an operation of tapping the cut icon 3 other than the selected cut icon 3 in the cut list 30 displayed on the cut selection screen, for example. The cut selection operation is not limited thereto, and for example, a swipe operation in the storyboard display field 31 may be input as a cut selection operation of changing the selected cut to an adjacent cut.

When the cut selecting operation is input ((I) in S3), the controller 210 changes the selected cut icon 3 according to the input cut selecting operation (S4), and performs the processing in and after step S2 again. As a result, on the cut selection screen, the selected cut icon 3 is changed, and the storyboard display field 31 is displayed for a new selected cut (S2).

The transition operation to the recording mode ((II) in S3) is a user operation for shifting to the recording mode, which is an operation mode for shooting a video related to the selected cut, and is a tap operation on the recording mode button 34, for example. Additionally or alternatively, the transition operation may be a swipe operation in a predetermined one of the ±X directions of the cut selection screen. The recording mode button 34 may be omitted.

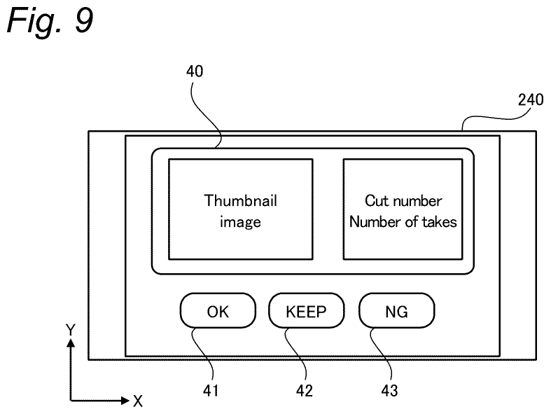

When the transition operation to the recording mode is input ((II) in S3), the controller 210 executes, as the recording mode, various processing for shooting a video of one take in association with the selected cut (S5). A display example in step S5 is illustrated in FIG. 9.

FIG. 9 illustrates a display example of a rating screen in the information support terminal 200. The rating screen is a screen for prompting the user to perform a rating for determining the rating of the video of the imaged take. The rating screen is an example of a rating screen in the information support terminal 200 according to the present embodiment.

As illustrated in FIG. 9 the rating screen includes an information display field 40 for a shot video, an OK button 41, a KEEP button 42, and an NG button 43 as rating options, for example. The information display field 40 displays information related to the video of the shot take, and includes a thumbnail image of the video of the take, a cut number associated with the take, and the number of takes, for example.

The OK button 41 indicates a rating “OK” indicating that the user has determined to want to adopt the take for the corresponding cut, for example. The KEEP button 42 indicates a rating “KEEP” on which it is difficult for the user to determine whether or not to adopt the take, for example. The NG button 43 indicates a rating “NG (No Good)” in which the user has determined that it is clear that the take is not adopted, for example. In the present embodiment, the rating “NG” is an example of a first rating, and the ratings “OK” and “KEEP” are examples of a second rating.

In the recording mode processing (S5) according to the present embodiment, every time video shooting of one take is performed the rating screen of FIG. 9 is displayed to acquire rating information indicating a rating of the user of the take, for example. Details of the processing of step S5 will be described later.

In the information support terminal 200 according to the present embodiment, the controller 210 further performs determination processing of determining whether or not the video of the take is NG on the basis of the audio data in the video of the shot take (S7). The sound determination processing (S7) according to the present embodiment automatically determines, as NG, a take in which the collection of the sound by the performer in the scenario is insufficient, by using a sound source separation technology for separating, from various noises, a target sound emitted by a desired subject such as a human voice. Details of the processing of step S7 will be described later.

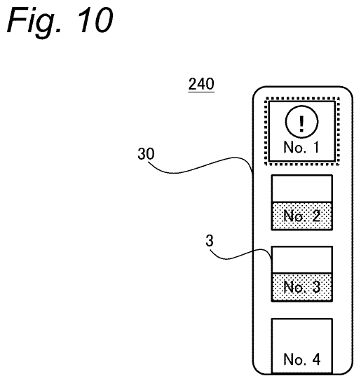

For example, the controller 210 performs the processing of step S1 again on the basis of user rating information (S5) and a sound determination result (S7) obtained for the video of the take as described above. Thus, the cut list 30 is updated to be visible to the user so as to reflect the rating result of the user and the automatic sound determination results for the new take of the selected cut (see FIG. 10).

The transition operation to the playback mode ((III) in S3) is a user operation for shifting to the playback mode, which is an operation mode for reproducing and displaying a video shot with respect to the selected cut, and is an operation of the playback mode button 35, for example. Additionally or alternatively, the transition operation to the playback mode may be a swipe operation in a direction opposite to the transition operation to the recording mode among the ±X directions of the cut selection screen. The playback mode button 35 may be omitted.

When the transition operation to the playback mode is input ((III) in S3), the controller 210 executes processing of reproducing videos of various takes related to the selected cut as the playback mode (S6). In a playback mode processing (S6) in the present embodiment, re-rating for changing the rating on the video of each take can be executed. On the basis of the re-rating result of the playback mode processing (S6), the controller 210 performs the cut list generation processing (S1) again to update the cut list 30. Details of the processing of step S6 will be described later.

The end operation ((IV) in S3) is a user operation for ending the cut shooting function, and is an operation of the return button 15 on the cut selection screen (FIG. 7), for example. For example, when an end operation is input ((IV) in S3), the controller 210 causes the display 240 to transition from the cut selection screen to the function selection screen (FIG. 4) and ends the processing illustrated in this flow.

According to the above processing, the user of the present system 10 can perform video shooting of a desired cut (S5) or perform playback display (S6) with checking various cuts on the cut selection screen (FIG. 7) in the cut shooting function of the information support terminal 200 (S4). In this way, the user can easily manage the video shooting of the plurality of cuts in the scenario.

In the present embodiment, the sound determination processing (S7) in the information support terminal 200 automatically determines NG (i.e., sound NG) in view of the sound collected in the video shot as each take for each cut, for example. FIG. 10 illustrates the cut list 30 updated in step S1 by reflecting such a determination result. In this example, as a take of the sound NG has occurred in the cut of the cut number, an identifier “!” for alert of the sound NG is assigned to the corresponding cut icon 3. The identifier is an example of alert information of the present system 10.

For example, the sound of the video to be shot at various shooting locations may be NG due to noise such as ringing of an insect or an animal (e.g., ringing of cicadas) or wind noise, resulting in insufficiently collecting the sound by the performer clearly. It is conceivable that manual check of the sound in the video for the NG due to the sound would take time and effort so that, and cannot sufficiently check the NG at the video shooting site with little time. Then, the cut in which the sound is NG tends to find at the time of video editing after returning home or the like from the video shooting site. This causes an unnecessary increase in man-hours in the process of video production, such as returning to the video shooting site again to re-shoot the corresponding cut video.

Therefore, by automating the determination of the mistake shot due to the mixture of the noise by the sound determination processing (S7), the information support terminal 200 according to the present embodiment can reduce the load on the user to check NG of the video. For example, the result of such NG determination can be viewed by the user with the updated cut list 30 or the like. Then, it is possible to alert the user that the video shooting is not completed due to the NG of the sound at the video shooting site. In this way, it is possible to reduce the number of man-hours for video production by the user of the present system 10 and save the labor load.

On the cut selection screen according to the present embodiment, each of the cut icons 3 is identified and displayed depending on whether or not the imaging is completed, and thus, it is possible to suppress a situation that a cut is forgotten by a user to shoot. As the identification display of whether or not imaging of each cut is completed is performed so as to reflect the rating of the video of each take by the user, it can be facilitated to ensure the video quality according to the intention of the user. Such rating is performed every time a take is shot (S5), and re-rating can be performed in the playback mode (S6). As a result, it is possible to easily realize quality management of video shooting according to the intention of the user.

The cut selection screen (FIG. 7) according to the present embodiment is not limited to the update of the cut list 30 according to the rating/re-rating of cuts as described above (S5, S6, S1), and may also be updated by filtering or adding cuts to the display target. As a result, the user can efficiently use a desired cut on the cut selection screen at the site of video shooting, and can easily use the cut shooting function of the present system 10, for example.

In the cut shooting function according to the present embodiment, communication connection with the digital camera 100 may be managed, and for example, a button for managing communication connection may be provided on the cut selection screen. When the communication connection with the digital camera 100 is not established, the controller 210 may disable the operation to transit to the recording mode ((II) in S3).

### 2.2.2. Recording Mode

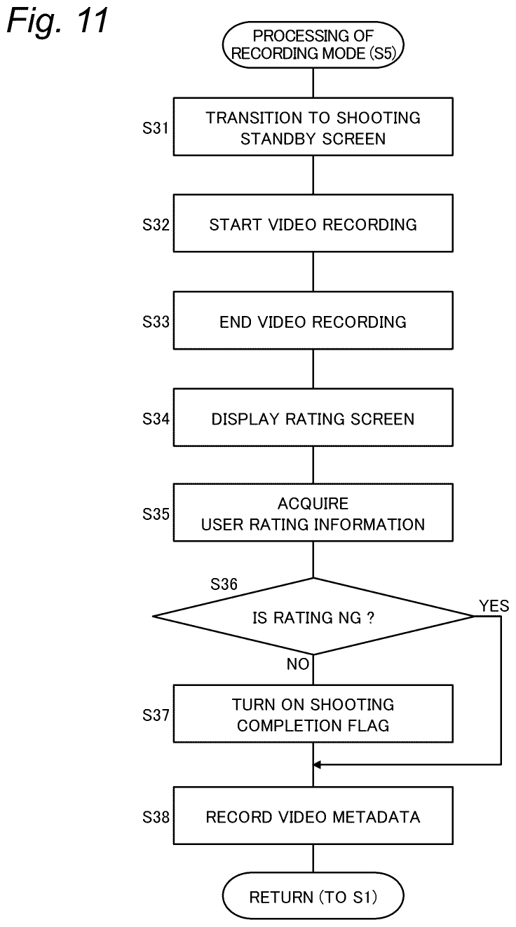

Details of the recording mode processing in step S5 of FIG. 8 will be described with reference to FIGS. 11 to 13.

FIG. 11 is a flowchart illustrating recording mode processing (S5) in the present system 10. The processing illustrated in the flow of FIG. 11 is started when a transition operation to the recording mode is input on the cut selection screen of FIG. 7, for example ((II) in S3).

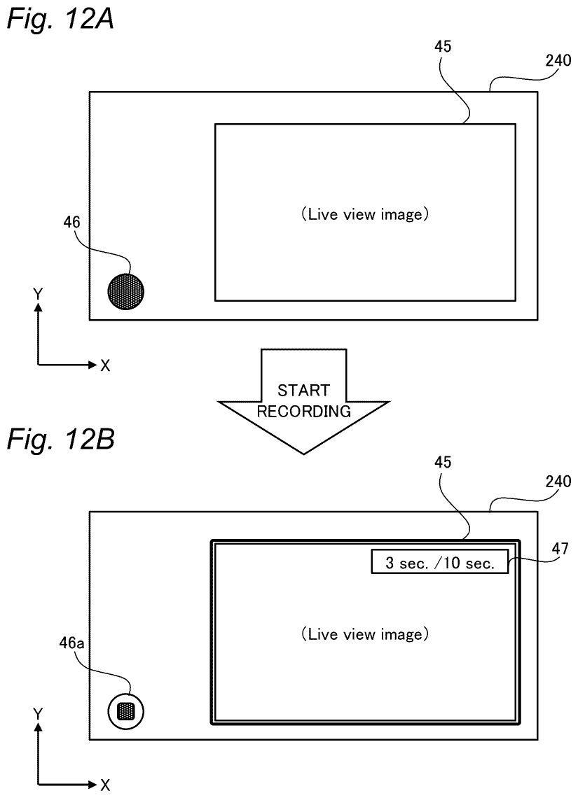

First, the controller 210 of the information support terminal 200 shifts to the recording mode and causes the display 240 to transition to a screen for waiting for video shooting (S31). FIG. 12A illustrates a display example of the information support terminal 200 in step S31.

As illustrated in FIG. 12A, the recording standby screen in step S31 includes a live view image 45, and a recording button 46, for example. The recording button 46 receives a user operation for starting shooting and recording of a video.

In the present system 10, when shifting to the recording mode, the controller 210 of the information support terminal 200 requests the digital camera 100 to transmit the live view image 45 via the communication interface 250, for example (S31). For example, in the recording mode, the controller 210 sequentially receives the image data of the live view image 45 from the digital camera 100 via the communication interface 250, and displays the live view image 45. For example, the controller 210 receives audio data of a sound collection result of the microphone 160 from the digital camera 100 in a timely manner.

In response to the user operation on the recording button 46, the controller 210 performs various types of control to start shooting and recording of the video of one take associated with the selected cut (S32). For example, in step S32, the controller 210 instructs the digital camera 100 to start shooting and recording of a video via the communication interface 250. A display example of the information support terminal 200 in step S32 is illustrated in FIG. 12B.

As illustrated in FIG. 12B, the vide shooting screen in step S32 includes the live view image 45, a time display field 47, and a recording stop button 46a, for example. For example, highlighting such as frame display indicating that recording is being performed is performed on the live view image 45 on the vide shooting screen. For example, the time display field 47 compares and displays the shooting time of the selected cut in the cut allocation data D1 with the elapsed time from the start of imaging of the video of the take.

In step S32, the controller 210 controls the display 240 to switch the display from the imaging standby screen (FIG. 12A) to the vide shooting screen (FIG. 12B). The controller 210 records a video file indicating the live view image 45 sequentially received from the digital camera 100 after the operation of the recording button 46 in the memory 220 of the information support terminal 200 (S32). The video file includes audio data collected by the microphone 160 in synchronization with video shooting by the digital camera 100, for example.

The controller 210 determines the file name of the video file on the basis of the cut allocation data D1 and the number of takes that have been shot for the selected cut, for example. The controller 210 may provide the determined file name in the instruction to the digital camera 100. The controller 135 of the digital camera 100 starts shooting of a video in accordance with an instruction from the information support terminal 200 received via the communication module 155, for example.

At this time, the controller 135 repeats the imaging operation of the image sensor 115 and records the video data of the shooting result in the memory card 142 via the card slot 140, for example. For example, the video data includes audio data of the sound collection result of the microphone 160. The controller 135 may start sound collection synchronized with video shooting in the digital camera 100 from such a shooting instruction. For example, on the vide shooting screen of FIG. 12B, the recording stop button 46a receives a user operation for stopping shooting and recording of a video.

Thereafter, the controller 210 performs various types of control so as to stop the shooting and recording of the video in response to the user operation of the recording stop button 46a (S33). For example, in step S33, the controller 210 instructs the digital camera 100 to stop shooting and recording of a video via the communication interface 250. The controller 210 stops video recording of the live view image 45 in the information support terminal 200 (S33). The controller 135 of the digital camera 100 ends shooting a video in accordance with an instruction from the information support terminal 200.

For example, in order to prompt the user to rate the video of the take shot as described above, the controller 210 displays a rating screen on the display 240, as illustrated in FIG. 9 (S34).

The controller 210 receives a user operation of the various buttons 41 to 43 on the rating screen as illustrated in FIG. 9, and acquires the rating of the user as a result of the rating of the video of the shot take, for example (S35). In the present embodiment, every time a video of one take is shot, a user can arbitrarily select a desired rating from the above three types of rating “OK”, “KEEP”, and “NG” for a video shot without interfering with rating of a video of another take in particular.

The controller 210 determines whether or not the rating is “NG” on the basis of the acquired rating of the user, for example (S36). For example, when the rating of the user is “OK” or “KEEP”, the determination in step S36 is “NO”.

When the acquired rating of the user is not “NG” (NO in S36), the controller 210 sets the shooting completion flag of the cut associated with the take (i.e., the selected cut) in the cut allocation data D1 to “ON” (S37). For example, in the case where the number of takes of the video is “1”, or the case where a rating of a video of an existing take is “NG” in the number of takes equal to or greater than “2”, the shooting completion flag is switched from “OFF” to “ON” by the execution of step S37.

On the other hand, when the acquired rating of the user is “NG” (YES in S36), the controller 210 proceeds to step S38 without particularly updating the setting of the shooting completion flag. Thus, when the shooting completion flag of the corresponding cut is in the OFF state when the video having the rating “NG” is shot, the OFF state is kept, for example. For example, when a video of a take shot in the past has “KEEP” or “OK”, and thus the shooting completion flag is in an ON state, the ON state is kept.

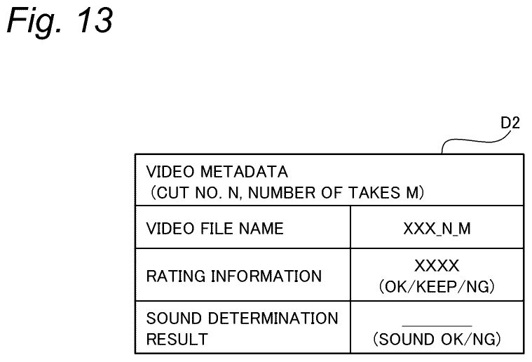

The controller 210 generates metadata of a video of a take shot as described above, and records the metadata in the cut allocation data D1 in the memory 220, for example (S38). Such video metadata D2 is illustrated in FIG. 13.

For example, as illustrated in FIG. 13, the video metadata D2 includes “video file name”, “rating information”, and “sound determination result”. The controller 210 provides the video file name determined to reflect the number of takes for the video shot in steps S32 to S33, the rating of the user acquired in step S35 in the video metadata D2. At the timing of step S38, “sound determination result” in the video metadata D2 has an empty value, for example.

The controller 210 stores the generated video metadata D2 in the video metadata list in the cut associated with the video in the cut allocation data D1 of FIG. 6 (S38). The video metadata D2 is not particularly limited to the above, and may include various types of setting information of long take shooting such as the number of takes in addition to or instead of the video file name, for example.

For example, the controller 210 ends the recording mode processing (S5) by storing the video metadata D2 (S38), and proceeds to step S7 of FIG. 8.

According to the recording mode processing (S5) described above, the present system 10 can shoot and record a video of one take of the selected cut and prompt the user to rate the cut (S32 to S35). The present system 10 manages an image shooting completion flag of the cut on the basis of the acquired rating information (S36, S37). In this way, the rating information of the user for each take can be appropriately reflected in the management of whether or not the cut is in the shooting completion state. In addition, according to the recording mode processing (S5) according to the present embodiment, the information support terminal 200 can control the shooting and recording of the video by the digital camera 100 to realize the management of the video shooting.

In the rating (S34 and S35) of the video of each take, a plurality of takes of the same rating may be present among a plurality of takes associated with the same cut. For example, a video of a plurality of takes for the same cut may have a rating “OK”.

In addition, the rating screen displayed in step S34 may be displayed as a dialog. For example, the controller 210 may control the display 240 to superimpose and display the dialog of the rating screen on the display screen before and after step S33.

For example, the recording standby screen in the recording mode (FIG. 12A) may further include a return button 15 for an operation of returning the screen transition to the cut selection screen. The return operation may be a swipe operation in a predetermined one of the ±X directions of the video management screen. The information support terminal 200 may shift to the playback mode by a swipe operation in the opposite direction.

### 2.2.3. Sound Determination Processing

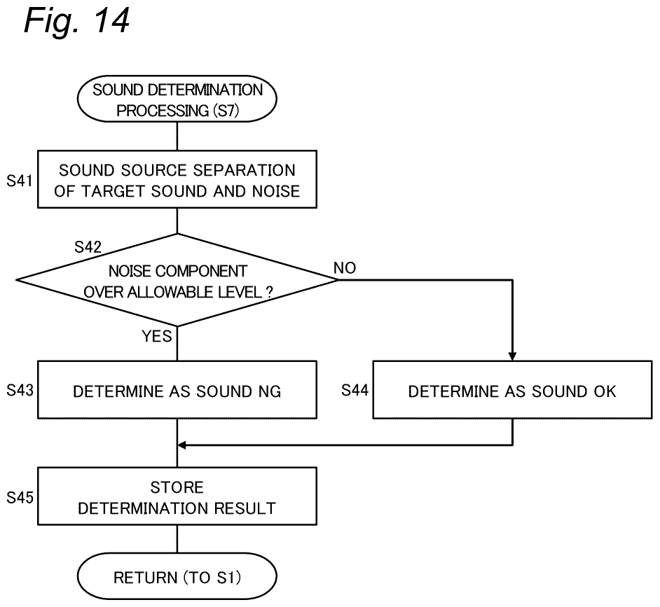

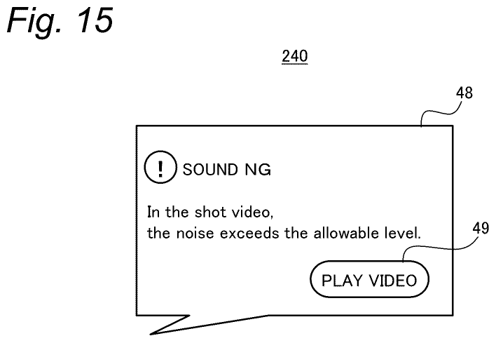

Details of the sound determination processing in step S7 of FIG. 8 will be described with reference to FIGS. 14 to 15.

FIG. 14 is a flowchart illustrating the sound determination processing (S7) in the present system 10. For example, The processing illustrated in the flow of FIG. 14 is started after the processing of shooting a video of one take (S5 of FIG. 8) is performed in association with the selected cut in the recording mode.

First, the controller 210 of the information support terminal 200 generates target sound data and noise data on the basis of the audio data of the video file obtained in step S5 so as to separate the component of the target sound and the component of the noise in the audio collected in the video, for example (S41). For example, the target sound data is audio data indicating the target sound component thus separated, and the noise data is audio data indicating a noise component.

In step S41, the controller 210 executes sound source separation processing using a trained model established by machine learning for a target sound and noise in advance, for example. Such sound source separation processing can be implemented using various known techniques, and e.g., can be performed by converting the target signal feature and the non-target signal feature output by the neural network model of JP 2022-141581 A from the frequency domain to the time domain.

Next, based on the noise data generated by the sound source separation processing (S41), the controller 210 detects whether or not a noise component is present over a predetermined allowable level for the sound in the video, for example (S42). For example, the allowable level is set to a volume level that is presumed to allow noise of audio data in video editing of the present system 10, and is an example of a predetermined level in the present embodiment.

For example, in step S42, the controller 210 sequentially compares the volume level of the noise data with the allowable level over the shooting period of the video, and in the case where the noise component exceeding the allowable level continues longer than the predetermined allowable period, the controller 210 proceeds to “YES”, and otherwise, the controller 210 proceeds to “NO”. For example, the allowable period is preset to a period of a length in which noise is presumed to be allowable in video editing of the present system 10.

The noise detection (S42) may be performed with reference to the target sound data, or may be mainly performed at the timing when the target sound is being emitted. The allowable level may be dynamically set according to the volume level of the target sound component, in view of difficulty for ensuring the clarity of the target sound due to the superimposition of noise. For example, the allowable level may be set to a sound level smaller by a predetermined margin from the sound level of the target sound component. As a result, when the sound level of the target sound component is further larger than the sound level of the noise component even it's large, the present system 10 can allow the noise without determination of a mistake shot as long as the difference is enough for the margin. In the audio data of the video, a time section that is assumed not to be used for the final video work may be excluded from the noise detection (S42) target.

When a noise component exceeding the allowable level is detected (YES in S42), the controller 210 determines the video of the take as “sound NG” (S43). The sound NG indicates a determination result that the video is NG (not adoptable) in the automatic sound determination by the present system 10.

On the other hand, when no noise component exceeding the allowable level has been detected (NO in S42), the controller 210 determines the video of the take as “sound OK” (S44). The sound OK indicates a determination result that the video is OK (adoptable) in the automatic determination of the sound by the present system 10.

Next, the controller 210 stores a determination result such as sound NG or sound OK for the take in the video metadata D2 of the memory 220, for example (S45). For example, the controller 210 stores the noise data and the target sound data of the take in association with the video metadata D2 in the memory 220.

For example, the controller 210 ends the sound determination processing (S7) by storing the determination result (S45), and proceeds to step S1 of FIG. 8. In this way, the controller 210 appropriately updates the cut list 30 on the basis of the rating information of the video metadata D2 and the sound determination result (see FIG. 10).

According to the sound determination processing (S7) in the present system 10, the sound source separation processing (S41) is not used for suppressing noise of the audio data of the video itself, but used for detecting the noise component exceeding the allowable level (S42). As a result, the sound source separation processing (S41) may not have the output sound with too high sound quality, and can be realized by a trained model with a reduced computation load according to such sound quality, for example.

By using noise data obtained as the output of the sound source separation processing (S41), the present system 10 detects a noise component (S42). According to this, the determination of sound NG can be implemented effectively for both of stationary noise and nonstationary noise. The result of such sound determination processing (S7) can be viewed by the user as alert information of sound NG in the cut list 30 (S41) updated thereafter, for example (FIG. 10). As a result, the user can immediately grasp the cut of the sound NG at the video shooting site when the take of the sound NG is shot, and can re-image the cut on the spot.

In the information support terminal 200 according to the present embodiment, the alert information of sound NG is not particularly limited to the example of the cut list 30 described above, and may be various information presentation. Such a modification will be described with reference to FIG. 15.

FIG. 15 illustrates a display example of an alert message 48 of sound NG in the information support terminal 200. In the present embodiment, when determining that the take is sound NG in step S43, the controller 210 of the information support terminal 200 may cause the display 240 to display the alert message 48 of sound NG as illustrated in FIG. 15, for example. The alert message 48 of this example may include a video playback button 49 that inputs a transition operation to a playback mode for playing the video of the take together with message information as an example of the alert information. In the information support terminal 200 according to the present embodiment, the alert information of sound NG may be various information presented to the user in the playback mode as described later.

In the above description, an example has been described in which the sound determination result and the rating information of the user are separately stored and independently managed in step S45. Instead of such independent management, the information support terminal 200 according to the present embodiment may update the rating information by a sound determination result, for example. For example, for a take of sound NG (S43), the controller 210 may change the rating information to “NG” when the rating information of the video metadata D2 at the rating of the user (S35 of FIG. 11) is “OK” or “KEEP”. In response to the change in the rating information in the video metadata D2, the controller 210 may manage the shooting completion flag of the cut. For example, when the rating information of all takes in the cut is “NG” after the change, the controller 210 updates the shooting completion flag of the cut from “ON” to “OFF”.

Alternatively, the present system 10 may perform the sound determination processing (S7) only when the rating result of the user is “OK” or “KEEP”. The controller 210 of the information support terminal 200 may skip the sound determination processing (S7) when the rating information is “NG” by referring to the video metadata D2 after the execution of the recording mode processing (S5).

In the present system 10, the timing at which the sound determination processing (S7) is executed is not particularly limited to the timing after the processing of shooting a video of one take (S5) in the recording mode. For example, the sound determination processing (S7) may be executed after shooting a video of a plurality of predetermined takes, or may be executed in response to an instruction of a user.

### 2.2.4. Playback Mode

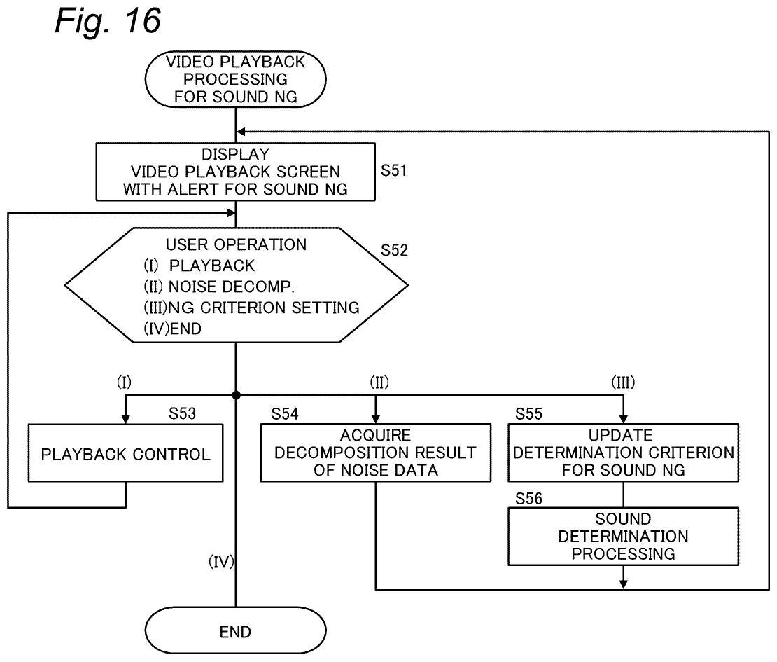

Hereinafter, an example of processing for video playback of a take of sound NG in the playback mode (S6 of FIG. 8) of the present system 10 will be described with reference to FIGS. 16 to 19.

FIG. 16 is a flowchart illustrating video playback processing for sound NG in the present system 10. For example, the processing illustrated in the flow of FIG. 16 is started when a transition operation to the playback mode is input on the cut selection screen of FIG. 7 or the alert message 48 of FIG. 15 ((III) in S3).

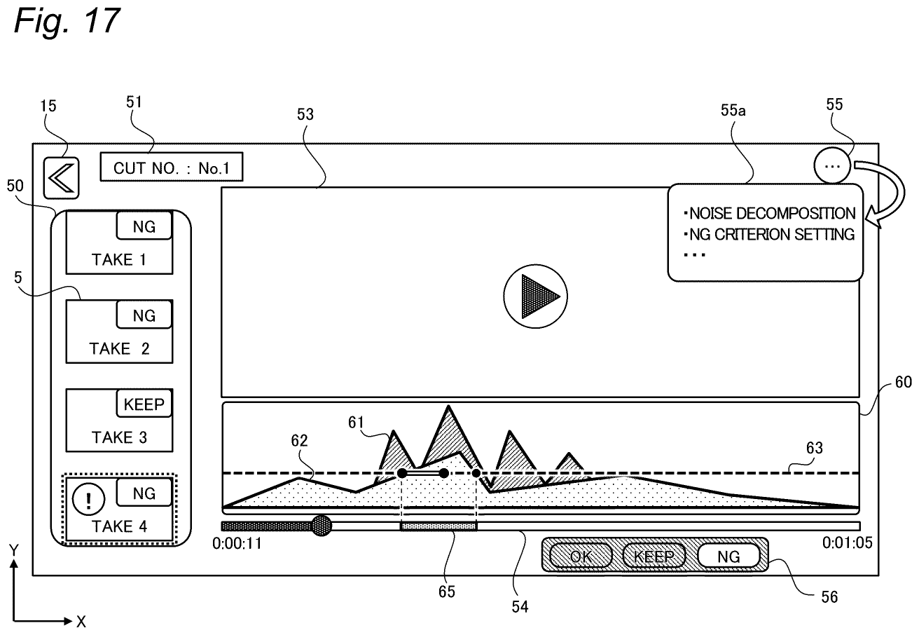

First, based on the video metadata D2 or the like including the result of the sound determination processing (S7), the controller 210 of the information support terminal 200 causes the display 240 to display a screen including alert information of a take of sound NG in the playback mode (S51). A display example of the information support terminal 200 in step S51 is illustrated in FIG. 17.

As an example illustrated in FIG. 17, the video playback screen in step S51 includes a cut identification field 51, a video list 50, a playback image 53, a playback control bar 54, a sound graph 60, a menu button 55, a re-rating panel 56, and a return button 15.

The cut identification field 51 displays identification information of the selected cut. The video list 50 includes a video icon 5 indicating a video for each take in the selected cut. For example, the video icon 5 is configured by superimposing the rating information on the thumbnail image of the video in the take. In the playback mode of the present system 10, the video of the video icon 5 selected in the video list 50 is displayed as the playback image 53.

The playback control bar 54 has a direction (X direction) corresponding to the time axis of the video to be played, for example. The playback control bar 54 indicates the playback timing in the time length of the entire video according to the position in the longitudinal direction, and receives a touch operation of changing the playback timing.

In the example of FIG. 17, as the video icon 5 of take 4 with the sound NG is selected in the video list 50, the controller 210 displays the sound graph 60 as an example of the alert information on the video playback screen (S51).

The sound graph 60 includes a target sound graph 61, a noise graph 62, and an allowable line 63. A horizontal axis of the sound graph 60 indicates a time axis similar to that of the playback control bar 54, and a vertical axis indicates a volume level. The target sound graph 61 indicates a volume level at each time in the target sound data of the video to be played. The noise graph 62 indicates a volume level for each time in the noise data of the video. The allowable line 63 indicates a determination criterion (e.g., an allowable level and an allowable period) for the sound NG in the sound determination processing (S7).

The sound graph 60 in the information support terminal 200 according to the present embodiment can facilitate the user to see an NG portion 65 that is a portion caused the sound NG in the video, which visualizes by the time range in which the noise graph 62 exceeds the allowable line 63. In the example of FIG. 17, the NG portion 65 is highlighted on the playback control bar 54. The NG portion 65 is an example of alert information in the present embodiment.

On the video playback screen of FIG. 17, the menu button 55 receives a touch operation of switching display/non-display of a selection menu 55a in the playback mode, for example. For example, the selection menu 55a includes menu items such as “noise decomposition” and “NG criterion setting” as options selectable by the user.

The re-rating panel 56 includes a plurality of buttons similar to the rating screen (FIG. 9) for re-rating the selected video again, for example. In this example, as the video of sound NG is being selected, the re-rating panel 56 is displayed in gray out so as to be invalidated.

In step S51, referring to the video metadata list of the cut in the cut allocation data D1, the controller 210 generates each video icon 5 so as to visualize the rating information of each take associated with the cut, for example. For example, the controller 210 further gives an identifier of a take of sound NG to the corresponding video icon 5 (S51). Such a video icon 5 is an example of alert information in the video list 50.

The controller 210 receives various user operations via the user interface 230 with the display 240 displaying the video playback screen as illustrated in FIG. 17, for example (S52). The target user operation in step S52 includes (I) a video playback operation, (II) a noise decomposition operation, (III) an NG criterion setting operation, and (IV) an end operation.

The video playback operation ((I) in S52) is various user operations for the user to play a desired portion in the video. For example, the user can switch the playback/pause of the video by a tap operation on the playback image 53 or change the playback position by a touch operation on the playback control bar 54.

When the user inputs a desired video playback operation ((I) in S52), the controller 210 performs various control for playing the video on the video playback screen according to the input video playback operation (S53), and performs the determination in step S52 again.

For example, the controller 210 sequentially displays the images for each frame of the video file stored in the memory 220 of the information support terminal 200 as the playback image 53 according to the playback position indicated by the playback control bar 54 (S51). The controller 210 causes the speaker 270 to output the audio indicated by the audio data of the video file in synchronization with such playback display, for example (S51).

The information support terminal 200 according to the present embodiment can prompt the user to selectively play the NG portion 65 in the video of the sound NG on the playback control bar 54 of the video playback screen (FIG. 17), for example (S51 to S53). According to thisy, the user of the present system 10 can immediately check the situation of the NG portion 65 at the video shooting, facilitating to find the cause of the sound NG, or to examine improvement measures at the time of shooting a video of a future take, for example.

In addition, the present system 10 performs information support of further decomposing and visualizing a sound component such as a noise component in a video of the sound NG, or applying user setting to a determination criterion for the sound NG.

The noise decomposition operation ((II) in S52) is a user operation of instructing execution of information support by decomposition of a noise component in the present system 10, and can be input by an operation of the selection menu 55a, for example.

For example, when the noise decomposition operation ((II) in S52) is input, the controller 210 of the information support terminal 200 executes sound analysis processing to decompose a sound indicated by noise data of a video into sound components each for a predetermined type, and acquires a noise decomposition result (S54). The predetermined type is set as a type of various noises presumed in video shooting, including e.g., barking of various organisms, wind sound, and wave sound.

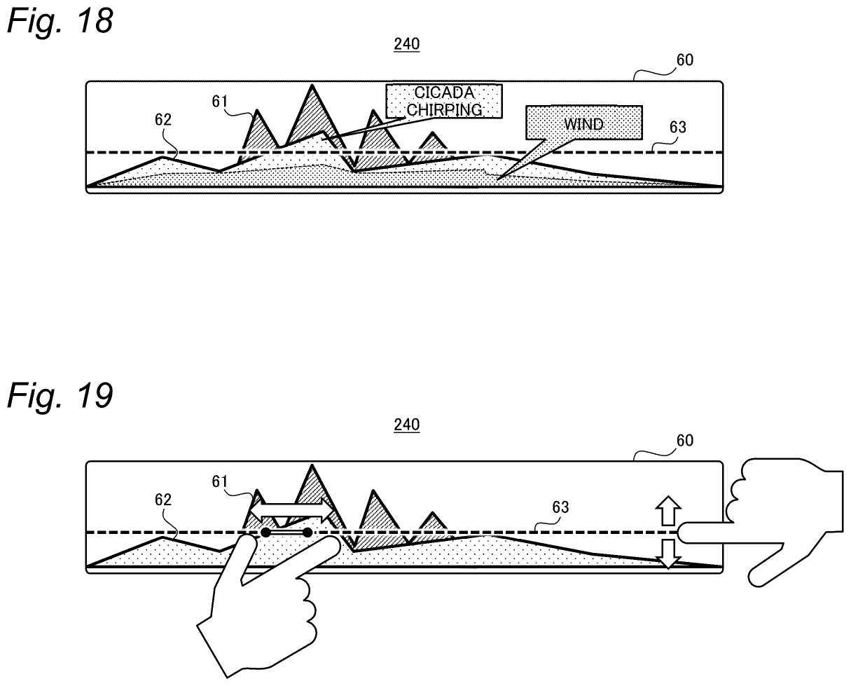

Next, the controller 210 performs the processing of step S51 again so as to update the video playback screen, based on the acquired noise decomposition result. A display example in which the noise decomposition result is reflected in the video playback screen is illustrated in FIG. 18.

FIG. 18 illustrates the sound graph 60 updated in accordance with the noise decomposition operation ((II) in S52) on the video playback screen illustrated in FIG. 17. In this example, the controller 210 of the information support terminal 200 updates the sound graph 60 so as to visualize the allocation for the plurality of types of sound components such as “cicada chirping” and “wind” in the noise graph 62 (S54, S51). The present system 10 realizes such visualization by sound analysis for specifying the type of the sound source of the sound component included in the noise.

As the sound analysis processing in step S54, the controller 210 detects a volume level including a sound component of a predetermined type in a volume level of noise data for each time, for example. Alternatively or additionally, the controller 210 may generate the audio data so as to separate the sound component for each type from the noise data. For example, such sound analysis processing may be performed by data collation using a database including various audio data, or may be performed by a trained model by machine learning using the database. The type of the sound source is not particularly limited to FIG. 18, and may include e.g. sound of a wave and barking of an organism such as various insects or animals.

Based on the noise decomposition result acquired as described above in step S54, as illustrated in FIG. 18, the controller 210 updates the sound graph 60 on the video playback screen to visualize the sound components of the noise for each type, for example (S51). According to this, the present system 10 can prompt the user to intuitively understand the type of noise causing the video of the take to be the sound NG, and can facilitate countermeasures against the noise in future video shooting. With the display of the sound source type of the sound component in the noise graph 62, the user can understand the sound source of the specific sound component in the noise, and it can facilitate to re-shoot a video for the cut.

The NG criterion setting operation ((III) in S52) is a user operation of changing the setting of the determination criterion in the sound determination processing (S7). This user operation can be input by a touch operation on the selection menu 55a and the sound graph 60, for example. Such an NG criterion setting operation in the information support terminal 200 will be described with reference to FIG. 19.

FIG. 19 illustrates the sound graph 60 with the menu item “setting of NG standard” being selected from the selection menu 55a of the video playback screen in (III) of step S52. For example, at this time, the controller 210 of the information support terminal 200 receives a drag operation in the Y direction of the allowable line 63 in the sound graph 60 on the touch panel of the user interface 230, to acquire a user setting for increasing or decreasing the allowable level of noise. The controller 210 receives a pinch-in/out operation of the allowable line 63 in the X direction, to acquire a user setting for shortening/extending the allowable period of noise.

For example, the user of the present system 10 can change the setting as described above in consideration of a volume level that can be suppressed by noise reduction processing available in the video editing PC 300 in the subsequent process, or in consideration of a degree to which noise such as an environmental sound is intentionally left in view of a production effect. The controller 210 updates the determination criterion for the sound NG according to such user setting (S55).

Next, for example, the controller 210 performs sound determination processing similar to that in step S7 on the basis of the updated determination criterion for the sound NG for the video of the take (S56), and returns to step S51. As a result, the sound graph 60 in the video playback screen of the take is updated by the new determination criterion.

The end operation ((IV) in S52) is a user operation of returning to the function selection screen from the playback mode, and may be an operation of the return button 15 on the video playback screen, for example. The end operation in (IV) in step S52 may be a swipe operation in a predetermined one of the ±X directions of the video playback screen, for example. The information support terminal 200 may shift to the recording mode by a swipe operation in the opposite direction.

For example, when the return operation ((IV) in S52) is input on the video playback screen of FIG. 17, the controller 210 ends the processing of this flow and returns to step S1 of FIG. 8, for example.

According to the above processing, the information support terminal 200 according to the present embodiment displays various alert information such as the sound graph 60 and the NG portion 65 on the video playback screen of the take of sound NG in the playback mode (S51). Accordingly, the present system 10 can prompt the user to check the sound NG of the video of the take.

For example, the user of the present system 10 can easily check the NG portion 65 in the video of the take of sound NG. For example, the user can check how the target sound is obstructed by noise from the target sound graph 61 and the noise graph 62 in the sound graph 60.

The present system 10 visualizes various sound components in the noise graph 62 (S54, S51), for example, as illustrated in FIG. 18, according to the noise decomposition operation of the user ((II) in S52). As a result, the user can check details of the noise component in the video of the sound NG, and can readily improve future video shooting.

For example, in the playback mode of the information support terminal 200, the present system 10 receives the NG criterion setting operation ((III) in S52) of the user, and updates the determination criterion of the sound determination processing in step S7 (S55). According to the user setting of the determination criterion for the sound NG, it can be facilitated to avoid a situation in which the present system 10 frequently performs the automatic determination of the sound NG against the user's intention, and to realize the automatic determination of the sound NG according to the intention of the user. The information support terminal 200 according to the present embodiment may receive the NG criterion setting operation ((III) in S52) particularly in a state other than the playback mode.

In the information support terminal 200 according to the present embodiment, the video playback screen in step S51 is not particularly limited to the example of FIG. 17. For example, in the example of FIG. 17, the NG portion 65 is displayed on the playback control bar 54, but in the present system 10, the NG portion 65 may be displayed on the allowable line 63 of the sound graph 60. In the example of FIG. 17, the NG portion 65 is displayed at one location, but for example, when the video includes a plurality of locations where the noise component exceeds the allowable level, a plurality of NG portions 65 may be displayed.

The sound graph 60 may not be displayed on the video playback screen of the take of sound NG in the present system 10. Even in this case, the present system 10 can alert the user of the time range of the sound NG by displaying the NG portion 65, for example. The present system 10 can also alert the user of each of the take and the cut of the sound NG by the identification display of the sound NG in the video icon 5 or the cut icon 3.

In the present system 10, the user operation received by the information support terminal 200 in the playback mode is not limited to (I) to (IV) in step S52, and another user operation may be received. For example, the controller 210 of the information support terminal 200 may perform the playback control of the selected video according to a user operation of selecting a video of a take other than the sound NG in the video list 50 as a playback target. The controller 210 may update the rating information of various takes according to a user operation of the re-rating panel 56.

In the above description, the sound analysis (S54) for decomposing the noise data in the present system 10 has been described, but the present system 10 is not particularly limited thereto. For example, the present system 10 may further perform the sound analysis as described above on the target sound data, or may perform the sound analysis on the audio data before the sound source separation. Then, the type of human voice or the like in the target sound component may be decomposed and visualized, for example.

The sound determination processing in step S56 may be executed not only for the video of the take but also for another take in the same cut, for example. In the present system 10, sound determination processing based on a new determination criterion may be performed for a video of another cut. In the present system 10, the user setting (S55) of the determination criterion for the sound NG may be performed for each cut, or may be a setting common between cuts.

### 3. Review

As described above, in the present embodiment, the information support terminal 200 is an example of an electronic device that manages video shooting. The information support terminal 200 includes a display 240 that displays information, a user interface 230 as an example of an input interface that inputs an operation of a user, and a controller 210 that controls the display 240 in accordance with the operation input on the user interface 230. The controller 210 receives an instruction to shoot a video in the user interface 230 (S5). The controller 210 acquires a result of determination processing of determining whether or not the video has failed to be shot such as sound NG, based on the audio data in the shot video, by executing the sound determination processing, for example (S7). When a result of the acquired determination processing indicates a mistake shot, the controller 210 causes the display 240 to display alert information for alert of the mistake shot of the video (see FIGS. 10,15, and 17).

According to the information support terminal 200 described above, by displaying the alert information to the user in response to the automatic determination of sound NG, it can facilitate to manage the mistake shot for sound collection in video shooting.

In the information support terminal 200 according to the present embodiment, in the determination processing, noise in the audio data is detected, and it is determined whether or not the video is the mistake shot, based on the detection result of the noise (S42). Accordingly, the present system 10 can realize automatic determination of sound NG due to noise, facilitating to manage a mistake shot due to noise in video shooting.

In the information support terminal 200 according to the present embodiment, in the determination processing, a sound component indicating noise is separated from a sound indicated by the audio data on the basis of the audio data of the video (S41), and the noise is detected on the basis of the sound component (S42). Accordingly, the present system 10 can realize the automatic determination of the sound NG on the basis of the sound source separation processing (S41), and can easily manage the mistake shot due to noise in the video shooting.

In the information support terminal 200 according to the present embodiment, the alert information includes at least one of a timing at which noise is detected in a video (e.g., the NG portion 65), or a volume level of noise (e.g., the noise graph 62). Accordingly, the present system 10 can visualize the noise that has caused the sound NG with the alert information, facilitating to manage the mistake shot due to the noise of the video shooting.

In the information support terminal 200 according to the present embodiment, by acquiring the decomposition result of the noise data (S54) on the basis of the operation of the user input to the user interface 230 ((II) in S52), the controller 210 controls the display 240 to visualize the plurality of sound components obtained by separating the audio indicated by the audio data into the plurality of types, for example (see FIG. 18). As a result, the user of the present system 10 can check various sound components in the video, and can easily manage a mistake shot for sound collection of video shooting.

In the information support terminal 200 according to the present embodiment, based on the user operation input to the user interface 230 ((III) in S52), the controller 210 sets a criterion for determining that the video is the mistake shot in the determination processing (S55). Accordingly, the present system 10 can easily manage the mistake shot by reflecting the intention of the user in the determination criterion of the mistake shot.

In the present embodiment, the information support terminal 200 further includes a memory 220 that stores cut allocation data DI as an example of management information for managing a video associated with one or a plurality of cuts in a scenario. The controller 210 receives an instruction to shoot a video in association with a specific cut among one or a plurality of cuts in the user interface 230 (S44), and acquires a result of determination processing for the video on the basis of audio data of the video to be shot in association with the specific cut (S7). Accordingly, the present system 10 can easily manage the mistake shot for sound collection in video shooting including one or a plurality of cuts.

In the present embodiment, the information support terminal 200 further includes the communication interface 250 that communicates data with the digital camera 100, which is an example of an imaging apparatus that executes video shooting. The controller 210 manages the video shot by the digital camera 100 by data communication via the communication interface 250 (S5). Accordingly, the information support terminal 200 separate from the digital camera 100 can facilitate to manage the video shooting for each cut.

In the present embodiment, an imaging management method for managing video shooting in a scenario including a plurality of cuts is provided. In the present method, the controller 210 of the information support terminal 200 receives an instruction to shoot a video in the user interface 230, acquires a result of determination processing of determining whether or not the video is a mistake shot on the basis of audio data in the shot video, and displays alert information indicating the mistake shot of the video on the display 240 in a case where the acquired result of the determination processing is a mistake shot.

In the present embodiment, a program for causing the controller 210 to execute the shooting management method is provided. According to such a shooting management method, it can facilitate to manage a mistake shot for sound collection in video shooting.

### SECOND EMBODIMENT

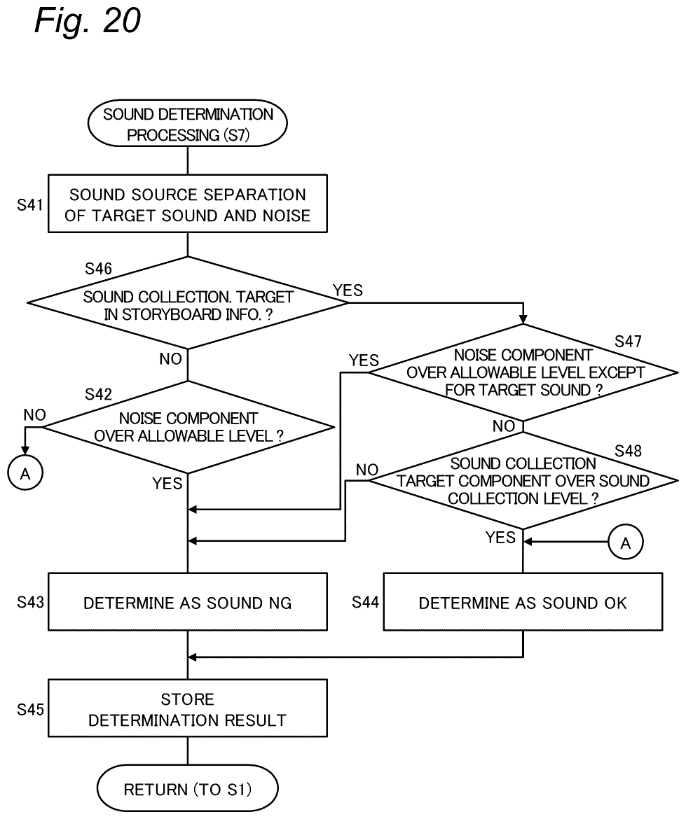

Hereinafter, a second embodiment of the present disclosure will be described with reference to FIG. 20. In the first embodiment, the information support terminal 200 that performs automatic determination of sound NG due to noise has been described. In the second embodiment, an information support terminal 200 that automatically switches and controls a sound to be regarded as noise in determination of sound NG will be described.

Hereinafter, description of configurations and operations similar to those of the imaging system 10 and the information support terminal 200 according to the first embodiment will be omitted as appropriate, and the imaging system 10 and the information support terminal 200 according to the present embodiment will be described.

FIG. 20 is a flowchart illustrating sound determination processing in the imaging system 10 of the second embodiment. In the present system 10, when performing the sound determination processing (S7 of FIG. 8) as in the first embodiment, the information support terminal 200 performs automatic control of the sound collection target as illustrated in FIG. 20 in addition to the execution of steps S41 to S45 similarly to FIGS. 14 (S46 to S48), for example.

For example, it is conceivable that the user of the present system 10 desires to make a desired sound such as cicada chirping not a noise but a target of sound collection intentionally in a specific cut in the entire scenario. For such a case, the present system 10 includes information (hereinafter referred to as “sound collection target information”) related to the sound to be collected in the storyboard information of the cut in the cut allocation data D1 by the user operation in the scenario planning function, for example. Hereinafter, a processing example using such sound collection target information in the present system 10 will be described.

For example, in the information support terminal 200 according to the present embodiment, referring to the cut allocation data D1 stored in the memory 220, the controller 210 determines whether sound collection target information is included in the storyboard information of the selected cut in the video shooting of the cut (S46).

For example, the user can describe text information for specifying a sound collection target in a memo column, a script column, or the like of the storyboard information in the desired cut. For example, in step S46 in this case, the controller 210 performs language recognition processing such as keyword extraction on the storyboard information of the selected cut, and proceeds to “YES” when recognizing the text information as the sound collection target information. For example, the target regarded as the noise of the sound NG (S43) is determined to be the sound component of the noise data other than the sound collection target indicated by the sound collection target information, in this case.

For example, when the controller 210 particularly determines that no sound collection target information is present in the storyboard information (NO in S46), the processing in and after step S42 is performed similarly to the first embodiment.

On the other hand, when determining that the sound collection target information is present (YES in S46), the controller 210 detects presence or absence of a noise component exceeding an allowable level except for the sound collection target, based on the noise data obtained in step S41, for example (S47). For example, the determination in step S47 is made by the controller 210 performing processing similar to the sound analysis of the noise decomposition (S54 of FIG. 16) and comparing the volume level obtained by subtracting the sound component of the type matching the sound collection target from the noise data with the allowable level similarly to step S42.

When the noise component exceeding the allowable level is detected except for the sound collection target (YES in S47), the controller 210 determines the take as sound NG (S43). On the other hand, when no noise component exceeding the allowable level is detected except for the sound collection target (NO in S47), the controller 210 detects whether or not the sound component of the sound collection target exceeds a predetermined sound collection level, for example (S48).

For example, step S48 is performed to reflect whether or not the sound as the sound collection target is sufficiently collected in the determination of the sound NG in view of a production effect or the like. For example, the sound collection level is set to a sound volume level of a magnitude presumed from the above viewpoint. The processing of step S48 is performed similarly to the processing of step S42, using such a sound collection level, for example.

When the sound component of the sound collection target exceeding the sound collection level is not detected (NO in S48), the controller 210 determines the take as sound NG (S43). On the other hand, when the sound component of the sound collection target exceeding the sound collection level is detected (YES in S48), the controller 210 determines the take as sound OK (S44).

According to the above processing, the information support terminal 200 according to the present embodiment can realize automatic determination as to whether or not a specific sound is regarded as noise according to the intention of the user, by utilizing the sound collection target information included in the cut allocation data D1, for example (S46). By utilizing the cut allocation data D1, it is possible to easily reflect the sound collection target intended by the user of the present system 10 in the automatic determination.

In the present system 10, the sound collection target information is not particularly limited to text information, and may be image information, for example. For example, in the case where the composition in the storyboard information is an illustration of a landscape without including a subject such as a performer, it is presumed that the user intends to set an environmental sound as a sound collection target. Therefore, in such a case, the information support terminal 200 according to the present embodiment may recognize the composition of just the scenery as the sound collection target information of the environmental sound by the image recognition of the storyboard information (YES in S46).

In the present embodiment, the sound collection target information is not particularly limited to the cut allocation data D1, and may be various management information stored in the memory 220 for shooting a video in the present system 10.

The present system 10 may use the sound collection target information for input of the sound source separation processing (S41). For example, the controller 210 may determine the sound collection target information before step S41 (S46) and control the sound source separation processing so that the type of the sound collection target indicated by the sound collection target information is to be separated.

As described above, the information support terminal 200 according to the present embodiment further includes the memory 220 that stores management information for managing a video. When the management information includes information indicating sound to be collected (YES in S46), the controller 210 determines a target to be regarded as noise in the audio data according to the sound for the sound collection target information (S47). Accordingly, in a case where a sound to be collected is designated, the information support terminal 200 according to the present embodiment can easily manage the sound collection mistake shot by reflecting the sound as the sound collection target in the detection of noise and performing the mistake shot determination processing.

In the information support terminal 200 according to the present embodiment, in the above case (YES in S46), the controller 210 may control the determination processing so as to detect noise by excluding the sound as the sound collection target from the sound indicated by the audio data, and to determine a mistake shot according to the smallness of the sound as the sound collection target (S47, S48).

### OTHER EMBODIMENTS

As described above, the first and second embodiments have been described as an example of the technology disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment.

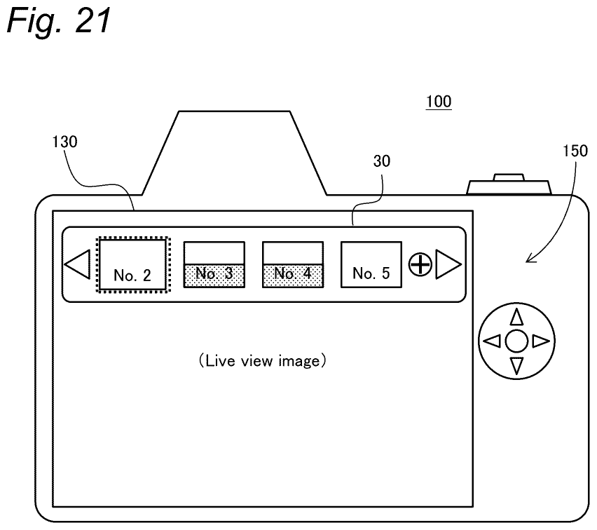

In the first embodiment described above, the information support terminal 200 has been described as an example of an electronic device different from the imaging apparatus, but the present disclosure is not limited thereto. The electronic device according to the present embodiment may be integrated with an imaging apparatus that performs video shooting. Such a modification will be described with reference to FIG. 21.

FIG. 21 illustrates a modification of the digital camera 100. In the present embodiment, the digital camera 100 has various functions such as the above-described cut shooting function of the information support terminal 200. For example, as illustrated in FIG. 21, the controller 135 of the digital camera 100 displays a cut selection screen including a plurality of cuts by the cut list 30 on the display monitor 130, and receives the cut selection by the user through the user interface 150 such as a touch panel or an operation button.

In the example of FIG. 21, the display monitor 130 superimposes and displays the cut list 30 on the live view image. The controller 135 of the digital camera 100 generates video data by an imaging operation of the image sensor 115 and a sound collection operation of the microphone 160, for example. The controller 135 of the digital camera 100 can perform automatic determination of sound NG and display various alert information on the display monitor 130, similarly to the sound determination processing (S7) of each of the above embodiments. Similarly to the first embodiment, the digital camera 100 can also provide the user with the information support by the cut shooting function and the export function.

As described above, in the present embodiment, the digital camera 100 as an example of an electronic device further includes the image sensor 115 as an example of an image sensor that captures a subject image and generates image data. The controller 135 manages a video including image data generated by the image sensor 115. Consequently, the digital camera 100 can facilitate to manage the video shooting.

In the above embodiments, the cut selection screen including the cut list 30 has been exemplified, but the selection screen of the present disclosure is not limited thereto. The selection screen according to the present embodiment may not include the cut list 30, and may include a plurality of cuts in a display mode different from the cut icon 3. In addition, the selection screen according to the present embodiment may be a dialog display, or may be superimposed and displayed on various display screens. In the present embodiment, the cut list 30 may be an example of the selection screen. In the present embodiment, the selection screen of the information support terminal 200 may identify and display whether or not the video shooting has been completed for each cut in various display modes other than the above-described example.

In the above embodiments, three types of examples in which the rating information is “OK”, “KEEP”, and “NG” have been described, but the rating information is not particularly limited thereto. In the present embodiment, the rating information may be three types of rating different from the above, and is not particularly limited to three types, and may be two types or four or more types. In the present embodiment, the rating information may be a score of a continuous value. The electronic device according to the present embodiment may receive a user input of such various types of rating information and manage video shooting for each cut. For example, the identification display can be performed by appropriately providing a criterion as to whether or not the video shooting of the cut is completed.

In the above embodiments, the imaging system 10 using the information based on the rating of the user has been described, but the present system 10 may not use the rating information of the user. In the present embodiment, the information support terminal 200 may perform the automatic determination of the sound NG without particularly using the rating information of the user. As a result, similarly to the above embodiments, the present system 10 can facilitate to manage the mistake shot for sound collection in video shooting.

In the above embodiments, the operation example in which the cut allocation data D1 includes a plurality of cuts has been described. However, in the present system 10, the number of cuts of the cut allocation data D1 may be one. In the information support terminal 200 according to the present embodiment, the cut allocation data DI and the scenario planning function may not be particularly used. Even in such a case, the information support terminal 200 according to the present embodiment can automatically determine the sound NG according to preset noise and target sound, for example.

In the above embodiments, the operation example in which the controller 210 of the information support terminal 200 executes each processing such as the sound determination processing (FIG. 14) has been described, but the present system 10 is not particularly limited thereto. For example, in the present embodiment, the sound source separation processing in step S41 of FIG. 14 may be executed by an external server that communicates data with the information support terminal 200. For example, the controller 210 according to the present embodiment may transmit the audio data of the video to the external server via the communication interface 250 in step S41, receive the result of the sound source separation from the external server, and perform the processing in and after step S42. Alternatively, the controller 210 may detect the noise of the sound NG by receiving the sound determination result from the external server. For example, sound analysis of noise decomposition (S54 of FIG. 16) may also be executed by an external server instead of the information support terminal 200, similarly to the above.

As described above, the information support terminal 200 according to the present embodiment may further include the communication interface 250 that communicates data with the external server that executes the determination processing. The controller 210 may transmit the audio data to the external server via the communication interface 250 and receive the result of the determination processing on the audio data from the external server via the communication interface. As a result, similarly to the above embodiments, the present system 10 can facilitate to manage the mistake shot for sound collection in video shooting. Such an external server and the information support terminal 200 may constitute a network type system. The external server can be configured by an information processing device such as various computers including a CPU and the like.

The present system 10 is not limited to automatic determination of sound NG, and may perform automatic determination on an image in video shooting, for example. The information support terminal 200 according to the present embodiment may perform image recognition as to presence or absence of a reflection of a person or the like different from a user-desired subject such as a performer in video shooting, based on the cut allocation data D1, for example. When the reflection is recognized, the controller 210 of the information support terminal 200 may automatically determine that the take is NG. Such image recognition may be performed inside the information support terminal 200 or may be performed outside.

In the above embodiments, the digital camera 100 including the optical system 110 and the lens driver 112 has been exemplified. The imaging apparatus according to the present embodiment may not particularly include the optical system 110, the lens driver 112, and the like, and may be an interchangeable lens type camera, for example.

In the above embodiments, the digital camera has been described as an example of the imaging apparatus, but the present disclosure is not limited thereto. The imaging apparatus of the present disclosure has only to be an electronic device having an imaging function (e.g., a video camera, a smartphone, a tablet terminal, or the like). The electronic device of the present disclosure does not particularly need to have an image imaging function, and may be various electronic devices.

### ASPECT EXAMPLES

Hereinafter, various aspects of the present disclosure will be exemplified.

A first aspect according to the present disclosure is an electronic device for managing video shooting. The electronic device includes: a display that displays information; an input interface that inputs a user operation; and a controller that controls the display according to the user operation input in the input interface. The controller receives an instruction to shoot a video in the input interface, and acquires a result of determination processing to determine whether or not the video is a mistake shot, based on audio data in the shot video. When the acquired result of the determination processing is the mistake shot, the controller displays alert information indicating the mistake shot of the video on the display.

A second aspect is the electronic device according to the first aspect, wherein the determination processing detects noise in the audio data to determine whether or not the video is the mistake shot, based on a detection result of the noise.

A third aspect is the electronic device according to the second aspect, wherein based on the audio data of the video, the determination processing separates a sound component indicating the noise from a sound indicated by the audio data, to detect the noise based on the sound component.

A fourth aspect is the electronic device according to the second or third aspect, wherein the alert information includes at least one of a timing at which the noise is detected or a volume level of the noise in the video.

A fifth aspect is the electronic device according to any one of the first to fourth aspects, further including a memory that stores management information managing a video. When the management information includes information indicating a sound subject to collect sound, the controller determines a target to be detected as noise in the audio data according to the information indicating the sound subject to collect sound.

A sixth aspect is the electronic device according to the fifth aspect, wherein when the management information includes information indicating the sound subject to collect, the controller controls the determination processing to detect the noise with the subject sound removed from the sound indicated by the audio data.

A seventh aspect is the electronic device according to any one of the first to sixth aspects, wherein the controller controls the display to visualize a plurality of sound components, based on the user operation input to the input interface, the plurality of sound components being components of an audio indicated by the audio data separated as a plurality of types.

An eighth aspect is the electronic device according to any one of the first to seventh aspects, wherein the controller sets a criterion for determining that the video is the mistake shot in the determination processing, based on the user operation input to the input interface.

A ninth aspect is the electronic device according to any one of the first to eighth aspects, further including a memory that stores management information managing the video associated with one or more cuts in the scenario. The controller receives the instruction to shoot the video in association with a specific section of the one or more sections in the input interface, and acquires the result of the determination processing for the video, based on the audio data in the video shot in association with the specific section.

A tenth aspect is the electronic device according to any one of the first to ninth aspects, further including a communication interface that communicates data with an imaging apparatus for shooting the video, wherein the controller manages the video shot by the imaging apparatus, based on data communication via the communication interface.

An eleventh aspect is the electronic device according to any one of the first to tenth aspects, further including an image sensor that captures a subject image to generate image data, wherein the controller manages the video including the image data generated by the image sensor.

A twelfth aspect is a shooting management method for managing video shooting. The method includes: receiving, by a controller of an electronic device, an instruction to shoot a video in an input interface, acquiring, by the controller, a result of determination processing to determine whether or not the video is mistake shot, based on audio data in the shot video, and displaying, by the controller, alert information on a display in response to the result of the acquired determination processing as the mistake shot, the alert information indicating the mistake shot of the video.

A thirteenth aspect is a non-transitory computer-readable recording medium storing a program for causing the controller to execute the shooting management method according to the twelfth aspect.

As described above, the embodiments have been described as an example of the technology in the present disclosure. For this purpose, the accompanying drawings and the detailed description have been provided. Accordingly, some of the components described in the accompanying drawings and the detailed description may include not only essential components for solving the problem but also components which are not essential for solving the problem in order to describe the above technology.

The present disclosure is applicable to various uses for shooting a video including sound collection.

1. An electronic device for managing video shooting, the electronic device comprising:
a display that displays information;
an input interface that inputs a user operation; and
a controller that controls the display according to the user operation input in the input interface, wherein
the controller
receives an instruction to shoot a video in the input interface,
acquires a result of determination processing to determine whether or not the video is a mistake shot, based on audio data in the shot video, and
when the acquired result of the determination processing is the mistake shot, displays alert information indicating the mistake shot of the video on the display.

2. The electronic device according to claim 1, wherein the determination processing detects noise in the audio data to determine whether or not the video is the mistake shot, based on a detection result of the noise.

3. The electronic device according to claim 2, wherein based on the audio data of the video, the determination processing separates a sound component indicating the noise from a sound indicated by the audio data, to detect the noise based on the sound component.

4. The electronic device according to claim 2, wherein the alert information includes at least one of a timing at which the noise is detected or a volume level of the noise in the video.

5. The electronic device according to claim 1,
further comprising a memory that stores management information managing the video,
wherein, when the management information includes information indicating a sound subject to collect sound, the controller determines a target to be detected as noise in the audio data according to the information indicating the sound subject to collect sound.

6. The electronic device according to claim 1, wherein the controller controls the display to visualize a plurality of sound components, based on the user operation input to the input interface, the plurality of sound components being components of an audio indicated by the audio data separated as a plurality of types.

7. The electronic device according to claim 1, wherein the controller sets a criterion for determining that the video is the mistake shot in the determination processing, based on the user operation input to the input interface.

8. The electronic device according to claim 1, further comprising a memory that stores management information managing the video associated with one or more cuts in the scenario, wherein
the controller
receives the instruction to shoot the video in association with a specific section of the one or more sections in the input interface, and
acquires the result of the determination processing for the video, based on the audio data in the video shot in association with the specific section.

9. The electronic device according to claim 1, further comprising a communication interface that communicates data with an imaging apparatus for shooting the video, wherein the controller manages the video shot by the imaging apparatus, based on data communication via the communication interface.

10. The electronic device according to claim 1, further comprising an image sensor that captures a subject image to generate image data, wherein the controller manages the video including the image data generated by the image sensor.

11. A shooting management method for managing video shooting, comprising:
receiving, by a controller of an electronic device, an instruction to shoot a video in an input interface,
acquiring, by the controller, a result of determination processing to determine whether or not the video is mistake shot, based on audio data in the shot video, and
displaying, by the controller, alert information on a display, the alert information indicating the mistake shot of the video when the acquired result of the determination processing is the mistake shot.

12. A non-transitory computer-readable recording medium storing a program for causing the controller to execute the shooting management method according to claim 11.
